(19) United States
(12) Patent Application Publication
(10) Pub. No.: US 2026/0338583 A1
(43) Pub. Date: Oct. 29, 2026

(54) DISPLACEMENT DETECTION SENSOR AND SENSOR DEVICE

(71) Applicant: NSD Corporation, Nagoya-shi, Aichi (JP)

(72) Inventor: Tomoshi TAKATSUKA, Nagoya-shi, Aichi (JP)

(21) Appl. No.: 19/168,993

(22) PCT Filed: Mar. 30, 2023
(86) PCT No.: PCT/JP2023/013198

§ 371 Date: Sep. 25, 2025

(51) Int. Cl. G01D 5/20

(52) U.S. Cl. CPC G01D 5/2046

(57) ABSTRACT

A displacement detection sensor is a sensor that detects two separated positions, and includes a primary coil unit to be excited by receiving supply of electric power from a signal source and a secondary coil unit disposed at a position to be magnetically coupled to the primary coil unit. The primary coil unit and the secondary coil unit change in inductances of the primary coil unit and the secondary coil unit when a measuring object configured of a magnetic body or a non-magnetic body having conductivity moves relative to the primary coil unit and the secondary coil unit. One of the primary coil unit and the secondary coil unit is configured to include two differentially-connected coils that are disposed away from each other.

### CROSS-REFERENCE TO RELATED APPLICATION(S)

This is a National Stage Entry into the United States Patent and Trademark Office from International Patent Application No. PCT/JP2023/013198, filed on Mar. 30, 2023, the entire contents of which are incorporated herein by reference.

### FIELD OF THE INVENTION

An embodiment of the present invention relates to a displacement detection sensor and a sensor device.

### BACKGROUND OF THE INVENTION

For example, in order to grasp a behavior of a moving object that undergoes linear displacement, such as a piston rod of a cylinder or a table of a slide table, the moving object may be detected at both ends in a moving range. As a sensor that performs such positional detection of linear displacement, for example, a reed switch to be operated by a magnet has been known for a long time. However, the reed switch includes a mechanical contact, and hence has problems such as being sensitive to vibration and being unstable in output or causing a contact failure due to deterioration over time. Moreover, the reed switch greatly varies from product to product, and is susceptible to disturbance caused by a DC magnetic field and also temperature. In addition, the reed switch has binary values of contact ON and OFF, and hence fine adjustment therefor is difficult. Fine adjustment becomes more difficult when a working space cannot be secured.

### SUMMARY OF THE INVENTION

In view of the above, as a sensor for performing positional detection of linear displacement, for example, a differential transformer not including a mechanical contact is also known. The differential transformer has an advantage of good linearity of response and being capable of successively detecting the position of the moving object because of using absolute detection. Moreover, the differential transformer has a differential configuration, and hence is easily increased in sensitivity and is excellent in a noise resistance characteristic and a temperature characteristic. Meanwhile, a range in which the position of the moving object can be detected by the differential transformer is about ½ of the entire length of the differential transformer, that is, a length corresponding to two differentially-connected coils. Accordingly, the differential transformer requires a coil having a length equal to or larger than two times the moving range of the moving object, and hence the coil is increased in length regardless of the detection range of the moving object. Thus, for example, even when the conventional reed switch is tried to be replaced with the differential transformer, there has been such a circumstance that it is difficult to secure an installing space.

Further, in the differential transformer, when a detection range varies, “output voltage/unit length” that is the output characteristic of the differential transformer, that is, the slope of the change in output voltage relative to the detection position varies. For example, the slope of the change in output voltage of the differential transformer having a detection range of 200 mm is ½ of the slope of the change in output voltage of the differential transformer having a detection range of 100 mm. Accordingly, even when only certain ranges from both ends of the moving range of the moving object are desired to be detected, a general differential transformer is required to vary in circuit configuration including the differential transformer for each moving range, and there has been such a circumstance that it is difficult to share a circuit configuration such as a signal source and a detector circuit.

The embodiment of the present invention has been made in view of the above-mentioned circumstances, and has an object to provide a displacement detection sensor and a sensor device with which, when only predetermined ranges from both ends of a moving range are to be detected, while an advantage of a differential transformer as described above is obtained, a circuit configuration can be shared even when a moving range varies.

A displacement detection sensor of an embodiment is a sensor that detects two separated positions, and includes a primary coil unit to be excited by receiving supply of electric power from a signal source, and a secondary coil unit disposed at a position to be magnetically coupled to the primary coil unit. The primary coil unit and the secondary coil unit change in inductances of the primary coil unit and the secondary coil unit when a measuring object configured of a magnetic body or a non-magnetic body having conductivity is moved relative to the primary coil unit and the secondary coil unit. One of the primary coil unit and the secondary coil unit is configured to include two differentially-connected coils disposed away from each other.

A sensor device of an embodiment includes the above-mentioned displacement detection sensor, and a converter that outputs a position signal indicating a position of the measuring object based on an induced electromotive force of the secondary coil unit, the converter including signal lines configured to have a two-wire system.

### BRIEF DESCRIPTION OF THE DRAWINGS

FIG. 1 is a diagram schematically illustrating an example of a circuit configuration when a detection result is output in analog in a sensor device according to an embodiment.

FIG. 2 is a diagram schematically illustrating a detection principle for an example of a sensor according to the embodiment.

FIG. 3 is a graph showing a relationship between a moving amount of a measuring object and output in the sensor device of FIG. 1.

FIG. 4 is a diagram schematically illustrating an example of a circuit configuration when a detection result is output in digital in the sensor device according to the embodiment.

FIG. 5 is a graph showing a relationship between the moving amount of the measuring object and the output in the sensor device of FIG. 4.

FIG. 6 is a diagram schematically illustrating a detection principle for another example of the sensor according to the embodiment.

FIG. 7 is a graph showing a relationship between the moving amount of the measuring object and the output when the sensor of FIG. 6 is used in the sensor device of FIG. 1 or FIG. 4.

FIG. 8 is a diagram schematically illustrating an example in which a coil is configured by winding a winding wire on a coil holder, in a mechanical configuration of the sensor according to the embodiment.

FIG. 9 is a diagram schematically illustrating an example in which a coil is configured of a pattern provided on a printed circuit board, in the mechanical configuration of the sensor according to the embodiment.

FIG. 10 is a diagram schematically illustrating an example of a converter in a case of configuring the sensor device according to the embodiment by a two-wire system.

FIG. 11 is a diagram schematically illustrating a first example of a sensor unit using the sensor according to the embodiment.

FIG. 12 is a diagram schematically illustrating a second example of the sensor unit using the sensor according to the embodiment.

FIG. 13 is a diagram schematically illustrating a third example of the sensor unit using the sensor according to the embodiment.

### DESCRIPTION OF EMBODIMENT(S) OF THE INVENTION

Hereinafter, a displacement detection sensor and a sensor device including the displacement detection sensor according to a plurality of embodiments are described with reference to the drawings. It is to be noted that, in the following description, the displacement detection sensor may be simply referred to as a sensor. Further, the same configuration is denoted by the same reference symbol to omit the description thereof.

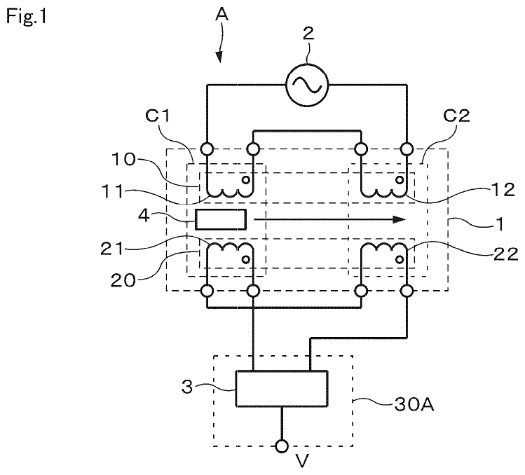

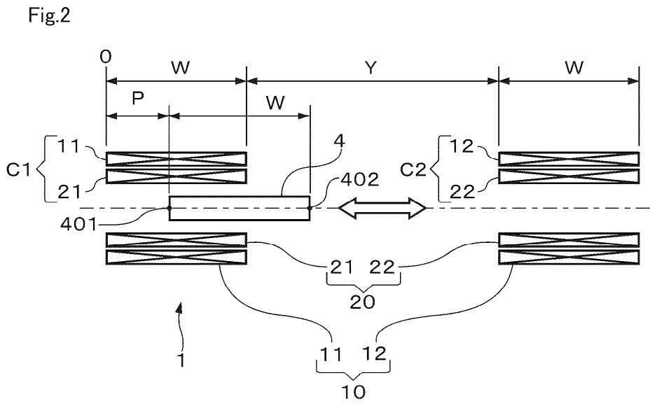

A sensor device A illustrated in FIG. 1 includes a sensor 1, a signal source 2, and a converter 30A. The sensor device A detects, as a detection target, an object that linearly reciprocates, such as a piston rod or a table, and detects two positions such as both end portions in a moving range of the detection target. The sensor 1 includes, as illustrated in FIG. 2 as well, a primary coil unit 10 and a secondary coil unit 20, and detects a position of a measuring object 4 mounted on the detection target. It is to be noted that a coil unit as used herein is a configuration including at least one coil.

The primary coil unit 10 is excited by receiving a signal output from the signal source 2. The secondary coil unit 20 is disposed at a position to be magnetically coupled to the primary coil unit 10. One of the primary coil unit 10 and the secondary coil unit 20 is configured to include two differentially-connected coils. The differentially-connected coils as used herein are defined as differential coils. In the case of the example of FIG. 1, the primary coil unit 10 includes two primary coils 11 and 12. The secondary coil unit 20 includes two secondary coils 21 and 22. The primary coils 11 and 12 and the secondary coils 21 and 22 can each be formed by winding a winding wire or the like such as a magnet wire including an insulated coating on an outer peripheral surface.

The primary coil 11 and the secondary coil 21, and the primary coil 12 and the secondary coil 22 each form a pair. Further, a pair of the primary coil 11 and the secondary coil 21, and a pair of the primary coil 12 and the secondary coil 22 are disposed away from each other. In the following description, one pair of the primary coil 11 and the secondary coil 21 may be referred to as a first coil set C1, and the other pair of the primary coil 12 and the secondary coil 22 may be referred to as a second coil set C2. Further, a distance between the first coil set C1 and the second coil set C2 may be referred to as a coil-to-coil gap length Y.

The two secondary coils 21 and 22 are disposed away from each other by a predetermined distance Y, that is, the coil-to-coil gap length Y. In addition, the two secondary coils 21 and 22 are, as illustrated in FIG. 1, differentially connected to be connected to a detector circuit 3 of the converter 30A. In this case, the two secondary coils 21 and 22 are respectively differential coils. Further, the two primary coils 11 and 12 are disposed away from each other by the distance Y, that is, the coil-to-coil gap length Y, similarly to the secondary coils 21 and 22. In addition, the two primary coils 11 and 12 are cumulatively connected to be connected to the signal source 2. Each of the coils 11, 12, 21, and 22 is formed into, for example, an annular or tubular shape. In addition, the two coil sets C1 and C2 are disposed on a coaxial line, that is, on a straight line, and are configured to allow the measuring object 4 to pass inside or outside of each of the coils 11, 12, 21, and 22.

The two primary coils 11 and 12 are respectively disposed at positions facing the secondary coils 21 and 22 that are differential coils, and are magnetically coupled to the facing secondary coils 21 and 22. That is, the primary coil 11 and the secondary coil 21 configuring the first coil set C1 are disposed at positions to be magnetically coupled to each other. Similarly, the primary coil 12 and the secondary coil 22 configuring the second coil set C2 are disposed at positions to be magnetically coupled to each other. In this case, the two primary coils 11 and 12 respectively face the two secondary coils 21 and 22. A coil facing the differential coil as used herein is defined as a facing coil. In the case of this embodiment, the two primary coils 11 and 12 are each a facing coil. In each of the coil sets C1 and C2, the primary coil 11 or 12 and the secondary coil 21 or 22 are disposed to overlap toward a right-angle direction with respect to a moving direction of the measuring object 4. In the case of this embodiment, the primary coils 11 and 12 are disposed on the outer peripheral side of the secondary coils 21 and 22. It is to be noted that the primary coils 11 and 12 may be disposed on the inner peripheral side of the secondary coils 21 and 22.

The signal source 2 is connected to the primary coils 11 and 12, and supplies electric power, that is, a voltage or a current for driving the sensor 1 to the primary coils 11 and 12. The signal source 2 supplies, for example, an AC signal to the primary coils 11 and 12. The converter 30A includes the detector circuit 3 and is connected to the secondary coils 21 and 22, and outputs a position signal, for example, a voltage indicating a position of the measuring object 4 based on an induced electromotive force of the secondary coils 21 and 22.

The measuring object 4 is mounted on the detection target, and moves along each of the coils 11, 12, 21, and 22 in accordance with the motion of the detection target. The measuring object 4 is provided to change the magnetic coupling of each of the coil sets C1 and C2 by moving inside or outside of each of the coils 11, 12, 21, and 22. The measuring object 4 is configured of a magnetic body or a non-magnetic body having conductivity. When the measuring object 4 is disposed inside of each of the coils 11, 12, 21, and 22, the measuring object 4 is preferably a magnetic body. Further, when the measuring object 4 is disposed on outside of each of the coils 11, 12, 21, and 22, the measuring object 4 is preferably a non-magnetic body having conductivity, such as copper, aluminum, or brass.

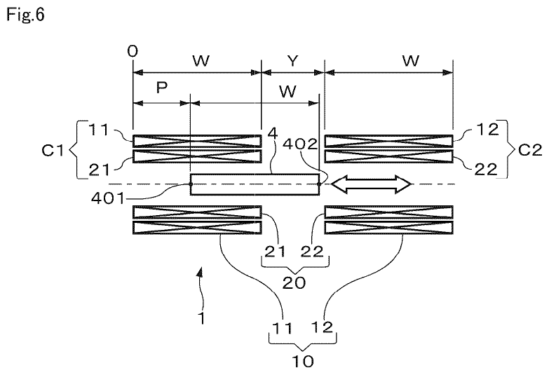

In the configuration of FIG. 2, a length dimension of the first coil set C1 may be referred to as a first coil set length, and a length dimension of the second coil set C2 may be referred to as a second coil set length. In the example of FIG. 2, the first coil set length and the second coil set length are both set to the same length dimension W. Further, in this embodiment, for the sake of easy description, a length dimension of the measuring object 4 in a traveling direction is also set to the same length dimension W as the first coil set length and the second coil set length. In this case, the coil-to-coil gap length Y is set to be longer than, for example, each coil set length W and the length dimension W of the measuring object 4. It is to be noted that the length dimension of the measuring object 4 is not always required to the same as the first coil set length and the second coil set length. Further, the coil-to-coil gap length Y is only required to be larger than 0. Although details are described later, for example, as illustrated in FIG. 6, the coil-to-coil gap length Y can be set to be shorter than each coil set length W and the length dimension W of the measuring object 4.

Further, in the following description, for the sake of convenience, an outer end portion, that is, a left end portion of the first coil set C1 on the left side of the drawing sheet of FIG. 2 is assumed as a reference position 0. In addition, a distance from the reference position 0 to a left end portion 401 of the measuring object 4 is assumed as a moving amount P of the measuring object 4. In this case, when the left end portion 401 of the measuring object 4 matches the reference position 0, that is, when the left end portion 401 of the measuring object 4 matches the outer end portion of the first coil set C1, the moving amount P=0 is obtained. In addition, when a right end portion 402 of the measuring object 4 matches a right end portion of the second coil set C2, that is, when the right end portion 402 of the measuring object 4 matches an outer end portion of the second coil set C2, the moving amount P becomes a value W+Y obtained by summing up the length dimension W of the measuring object 4 and the coil-to-coil gap length Y.

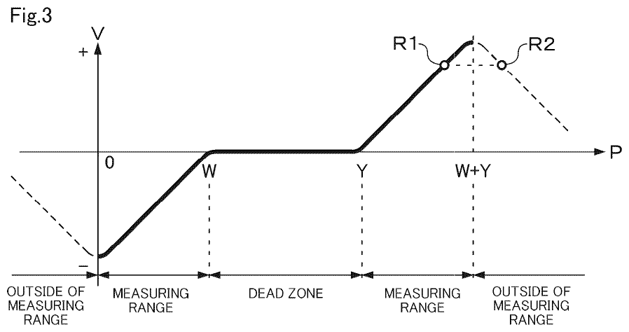

This configuration looks similar to a general differential transformer. However, the coil-to-coil gap length Y is provided between the two secondary coils 21 and 22 that are differential coils, and hence the behavior is different from the differential transformer. Hereinafter, an operation principle of the sensor 1 of this embodiment is described with reference to FIG. 3 as well.

FIG. 3 is a graph showing a relationship between a position of the measuring object 4 and an output voltage V. The vertical axis of the graph of FIG. 3 represents the output voltage V, and the horizontal axis represents the moving amount P. When the measuring object 4 stops at the reference position 0, the moving amount P=0 is obtained. In this case, as compared with a case of using a state in which the measuring object 4 is absent inside of the first coil set C1 as a reference, a change amount in inductances of the primary coil 11 and the secondary coil 21 in the first coil set C1 becomes the maximum. That is, in this case, the two differentially-connected secondary coils 21 and 22 are brought to a most unbalanced state, with the result that the output voltage V becomes the local maximum or the local minimum. Whether the output voltage V becomes the local maximum or the local minimum is determined in accordance with whether the measuring object 4 is a magnetic body or a non-magnetic body having conductivity, and the polarity of the detector circuit 3 or the like. In the example of FIG. 3, for the sake of convenience, the output voltage V is set to be the local minimum when the measuring object 4 is stopped at the reference position 0.

In FIG. 2, when the measuring object 4 moves in the right direction, that is, when the measuring object 4 moves from the first coil set C1 side to the second coil set C2 side, the inductance in the first coil set C1 reduces from the local maximum state when the measuring object 4 is a magnetic body, and increases from the local minimum state when the measuring object 4 is a non-magnetic body having conductivity. At this time, the inductance in the second coil set C2 does not change. This is because, between the two secondary coils 21 and 22, the coil-to-coil gap length Y that is larger than the length dimension W of the measuring object 4 is set, and, while a part of the measuring object 4 is positioned inside of one secondary coil 21, the measuring object 4 does not enter the inside of the other secondary coil 22.

When the measuring object 4 further moves to reach the moving amount P=W, the measuring object 4 comes out from the inside of the first coil set C1 to not affect the inductance of the first coil set C1. In this manner, the two differentially-connected secondary coils 21 and 22 are brought to the most balanced state, with the result that the output voltage V=0 is obtained as indicated in a section from W to Y of FIG. 3.

When the measuring object 4 further moves to exceed the moving amount P=W, until the moving amount P=Y is reached, a state in which both of the first coil set C1 and the second coil set C2 do not have a change in inductance due to the effect of the measuring object 4, that is, a state of the output voltage V=0 continues. Then, when the moving amount P=Y is obtained, the front end 402 of the measuring object 4 in the traveling direction becomes the same position as the left end of the second coil set C2. When the measuring object 4 further moves to exceed the moving amount P=Y, the measuring object 4 starts entering the inside of the second coil set C2 to start affecting the inductance of the second coil set C2.

In this case, when the measuring object 4 moves to exceed the moving amount P=Y, the inductance of the second coil set C2 increases when the measuring object 4 is a magnetic body, and decreases when the measuring object 4 is a non-magnetic body having conductivity. It is to be noted that, in the example of FIG. 3, for the sake of convenience, the output voltage V is set to become the local maximum when the measuring object 4 stops at a position of the moving amount P=W+Y.

In the example of FIG. 3, the above-mentioned operation can be summarized as follows regarding the range of the moving amount P of the measuring object 4 and the output voltage V.
0≤P<W: the output voltage V is negative, and increases along with the increase of the moving amount P
W≤P≤Y: the output voltage V is 0, and is not related to the increase of the moving amount P
Y<P≤W+Y: the output voltage V is positive, and increases along with the increase of the moving amount P

That is, in the example of FIG. 2 and FIG. 3, the ranges of 0≤P<W and Y<P≤W+Y are a measuring range in which the position of the measuring object 4 can be measured.

The above-mentioned sensor 1 is a sensor that detects two positions separated from each other. The sensor 1 includes the two differential coils 21 and 22, the facing coils 11 and 12, and the measuring object 4. The differential coils 21 and 22 are differentially connected to each other. The facing coils 11 and 12 are disposed at positions facing the respective differential coils 21 and 22 and at positions to be magnetically coupled to the differential coils 21 and 22. The measuring object 4 is configured of a magnetic body or a non-magnetic body having conductivity, and moves relative to the differential coils 21 and 22 and the facing coils 11 and 12 to change the magnetic coupling between the differential coils 21 and 22 and the facing coils 11 and 12 along with the movement. In addition, the two differential coils 21 and 22 are disposed away from each other by, for example, a distance equal to or larger than the length dimension W of the measuring object 4.

In the above-mentioned sensor 1, as illustrated in FIG. 2, ranges of the distance W from both ends of the moving range W+Y+W are the detection range. According to such a sensor 1, when only the predetermined ranges W from both ends of the moving range are to be detected, while the advantage of the differential transformer is obtained, the circuit configuration can be shared even when the moving range varies.

That is, in the above-mentioned sensor 1, the secondary coils 21 and 22 are differentially connected, and hence it is possible to obtain a characteristic equivalent or close to a general differential transformer regarding the disturbance noise and the temperature characteristic. That is, the sensor 1 includes no mechanical contact, and hence has less problem of malfunction due to lifetime, vibration, or the like, and has extremely small effects caused by characteristic fluctuations or deterioration over time. Further, the sensor 1 is less liable to receive an effect of a disturbance DC magnetic field as compared with a system using a magnet and a reed switch. Further, deviation of a detection position or the like is less liable to occur by a temperature characteristic, for example, temperature, derived from a magnetic component such as a magnet, and temperature correction is also allowed.

It is to be noted that the above-mentioned sensor 1 is different from the general differential transformer mainly in the following two points. The first points resides in that, in a state in which the measuring object 4 is positioned inside of the first coil set C1 or the second coil set C2, that is, regarding the moving amount P, in a range of 0≤P<W or Y<P≤W+Y, even when the inductance of one of the first coil set C1 and the second coil set C2 changes, the inductance of the other does not change. The second point resides in that, regarding the moving amount P, in a period of W≤P≤Y, a dead zone in which the output voltage V is maintained to substantially 0 appears.

Further, in an application of performing positional detection in the vicinity of both ends of the sensor 1, inconvenience is caused when there is a section in which the moving amount P of the measuring object 4 becomes P<0 or P>W+Y, that is, a section in which the measuring object 4 comes out from the left and right coil sets C1 and C2. For example, while a point R1 of FIG. 3 is positioned at Y<P<W+Y, a point R2 is positioned at P>W+Y. In this case, the points R1 and R2 both have the same value of the output voltage V, and the moving amount P cannot be identified from the output voltage V. Accordingly, in the application of performing positional detection in the vicinity of both ends of the sensor 1, it is preferred to provide a mechanical limit of restricting the movement of the measuring object 4 to fall within a section of 0<P<W+Y.

It is to be noted that the sensor device A having the above-mentioned configuration can be changed as follows.

The signal source 2 is not limited to a voltage source, and may be a current source.

The primary coil unit 10 is not required to have a configuration in which the two primary coils 11 and 12 are cumulatively connected, and may have a configuration in which a signal is applied independently to each of the two primary coils 11 and 12.

Even with a configuration in which the primary coils 11 and 12 of the primary coil unit 10 are differentially connected and the secondary coils 21 and 22 of the secondary coil unit 20 are cumulatively connected, a similar characteristic can be obtained.

Out of the primary coil unit 10 and the secondary coil unit 20, the coil unit in which differential connection is not established may be formed across the entire length of the moving range of the measuring object 4, that is, the length of 2W+Y.

The measuring object 4 is only required to be an object that can change the magnetic coupling of each of the coils 11, 12, 21, and 22, that is, an object that can change the inductance, and the material may be a magnetic material or a non-magnetic material having conductivity. When the measuring object 4 is configured of a non-magnetic material, it is possible to make the measuring object 4 less susceptible to the disturbance DC magnetic field that becomes a problem when a magnet and a reed switch are used.

Further, the shape of the measuring object 4 may be a columnar shape, a cylindrical shape, a bar shape, or a plate shape that passes through the inside of the coil sets C1 and C2, or may be a cylindrical shape or a rectangular tubular shape that surrounds the outside of the coil sets C1 and C2. Further, when the measuring object 4 is disposed on the outer peripheral side of the coil sets C1 and C2, the measuring object 4 may have a plate shape.

The signal processing performed in the converter 30A may not only be analog processing. A position signal can be digital data obtained by performing conversion into digital data by an A/D converter and then subjecting the data to digital processing by a CPU, an FPGA, or the like.

Each of the coils 11, 12, 21, and 22 may be a coil using a magnet wire, or a spiral coil may be disposed on a printed circuit board.

The primary coil unit 10 and the secondary coil unit 20 can have a half-bridge configuration in place of a mode of being separated from each other.

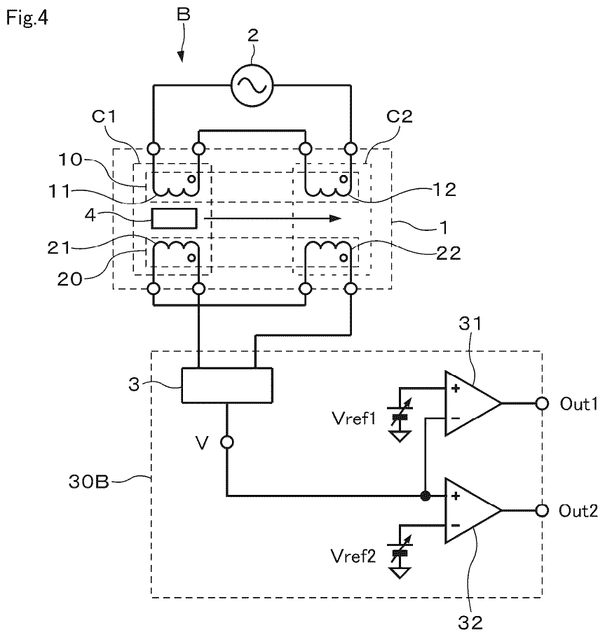

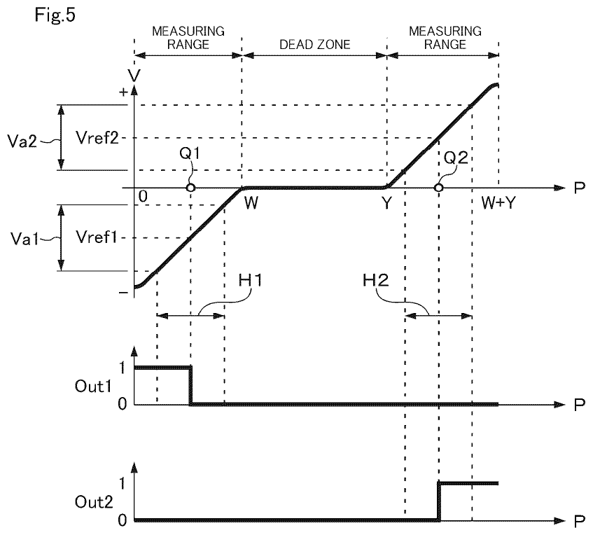

Next, with reference to FIG. 4 and FIG. 5, a sensor device B is described. The sensor device B illustrated in FIG. 4 and FIG. 5 is different from the sensor device A of FIG. 1 in including a converter 30B in place of the converter 30A of FIG. 1, and the same configuration of the sensor 1 is the same. It is to be noted that, in the following description, for the detection range of both ends of the moving range of the measuring object 4 with respect to the sensor 1, a region within a range in which the moving amount P becomes 0≤P<W may be referred to as a starting end side, and a region within a range in which the moving amount P becomes Y<P≤W+Y may be referred to as a terminating end side. The converter 30B has a function of converting an analog signal output from the detector circuit 3, that is, the output voltage V into a digital signal. The converter 30B includes, for example, two comparators 31 and 32. In the following description, one of the two comparators 31 and 32 may be referred to as a first comparator 31, and the other may be referred to as a second comparator 32.

In the example of FIG. 4, the first comparator 31 corresponds to detection on the starting end side, and the second comparator 32 corresponds to detection on the terminating end side. In the first comparator 31, the output voltage V is connected to the inverting input, and a first reference voltage Vref1 is connected to the non-inverting input. Meanwhile, in the second comparator 32, the output voltage V is connected to the non-inverting input, and a second reference voltage Vref2 is connected to the inverting input. The first reference voltage Vref1 and the second reference voltage Vref2 are reference voltages that can be adjusted by the user. Further, the output of the first comparator 31 is referred to as first output Out1, and the output of the second comparator 32 is referred to as second output Out2.

As shown in FIG. 5, an adjusting range Val of the first reference voltage Vref1 input to the first comparator 31 is preferred to be set in a range of a voltage actually output when the measuring object 4 is detected on the starting end side, in this case, slightly inside of the voltage range from the local minimum value to 0. Similarly, an adjusting range Va2 of the second reference voltage Vref2 input to the second comparator 32 is preferred to be set in a range of a voltage actually output when the measuring object 4 is detected on the terminating end side, in this case, slightly inside of the voltage range from 0 to the local maximum value. This is to prevent an error of threshold value determination due to a temperature drift of the circuit or the sensor 1, a disturbance noise, fluctuations of a component, or the like.

The user can set each of the first reference voltage Vref1 and the second reference voltage Vref2 to any value within each of the adjusting ranges Va1 and Va2. That is, the user can adjust the first reference voltage Vref1 within the adjusting range Va1 to adjust a detection position Q1 on the starting end side within an adjusting range H1. Similarly, the user can adjust the second reference voltage Vref2 within the adjusting range Va2 to adjust a detection position Q2 on the terminating end side within an adjusting range H2. That is, the sensor 1 can individually adjust the first reference voltage Vref1 and the second reference voltage Vref2 to individually adjust the detection position Q1 on the starting end side and the detection position Q2 on the terminating end side. In the example of FIG. 5, the first reference voltage Vref1 is set at an intermediate point of the adjusting range Va1 of the first reference voltage Vref1. Similarly, the second reference voltage Vref2 is set at an intermediate point of the adjusting range Va2 of the second reference voltage Vref2.

As viewed from the starting end side, when the moving amount P of the measuring object 4 is P=0, that is, when the measuring object 4 is positioned at the starting end of the detection range, the output voltage V is less than the first reference voltage Vref1. In this case, the first output Out1=1 is obtained. In addition, when the moving amount P of the measuring object 4 exceeds the position Q1 corresponding to the first reference voltage Vref1, the output voltage V becomes larger than the first reference voltage Vref1. In this manner, the first output Out1=0 is obtained. That is, the relationship between the moving amount P of the measuring object 4 and the first output Out1 is as follows.
0≤P≤Q1: First output Out1=1
Q1<P≤W+Y: First output Out1=0

Further, as viewed from the terminating end side, when the moving amount P of the measuring object 4 does not exceed the position Q2 corresponding to the second reference voltage Vref2, the output voltage V becomes less than the second reference voltage Vref2. In this case, the second output Out2=0 is obtained. In addition, when the moving amount P of the measuring object 4 is equal to or more than the position Q2 corresponding to the second reference voltage Vref2, the output voltage V is equal to or more than the second reference voltage Vref2. In this manner, the second output Out2=1 is obtained. That is, the relationship between the moving amount P of the measuring object 4 and the second output Out2 is as follows.
0≤P<Q2: Second output Out2=0
Q2≤P≤W+Y: Second output Out2=1

As described above, the user can freely adjust each of the first reference voltage Vref1 and the second reference voltage Vref2 within a range of each of the adjusting ranges Va1 and Va2. In addition, the sensor device B outputs the detection result of each of the starting end side and the terminating end side by a binary value of 0 or 1. Accordingly, a higher-level device such as a PLC (Programmable Logic Controller) can extremely easily import the result of the positional detection output from the sensor device B.

Further, in the sensor device B, the converter 30B having the function of adjusting the positions Q1 and Q2 is not incorporated in the sensor 1. Accordingly, the converter 30B can be installed at a place separated from the sensor 1, that is, a place at which human can easily work, with the result that the workability regarding adjustment can be improved.

Further, in the above-mentioned configuration, the first output Out1 represents a behavior of the measuring object 4 on the starting end side, and the second output Out2 represents a behavior of the measuring object 4 on the terminating end side. In this case, the length dimensions W of the coil sets C1 and C2 match the detection ranges on the starting end side and the terminating end side. That is, the length dimensions W of the coil sets C1 and C2 and the detection ranges on the starting end side and the terminating end side keep a constant relationship. Accordingly, at the time of designing the sensor 1, the length dimensions W of the coil sets C1 and C2 can be determined based on the detection ranges on the starting end side and the terminating end side, and hence the sensor 1 can be easily designed.

Here, the coil-to-coil gap length Y does not affect the output voltage V. Accordingly, in the sensor 1 having the above-mentioned configuration, with the coil-to-coil gap length Y being changed without changing the length dimensions W of the coil sets C1 and C2, it is possible to adapt to the change in moving range of the measuring object 4 in the sensor 1, that is, the change in moving range of the detection target, without changing positional detection characteristics in the vicinity of both ends. In this case, for example, in FIG. 2, even when the coil-to-coil gap length Y is changed without changing the length dimensions W of the coil sets C1 and C2, the length of the dead zone of W≤P≤Y illustrated in FIG. 3 and FIG. 5 only changes, and the output characteristic of the sensor 1 does not change in the section of 0≤P<W and the section represented by Y<P≤W+Y.

Accordingly, when the sensor 1 is designed in accordance with the moving range of the detection target, that is, the moving range of the measuring object 4, such as the stroke of the piston, the designer is only required to change the coil-to-coil gap length Y in accordance with its moving range, and, in this case, the circuit configuration of the sensor device B is not required to be changed. That is, with the above-mentioned configuration, regardless of the moving range of the measuring object 4, the circuit configuration of the sensor device B can be shared.

Further, regardless of the moving range of the measuring object 4, the coil units 10 and 20 of the sensor 1 may have the same number of turns or the same length dimension W, and hence a load at the time of design can be reduced. In addition, with the circuit configuration of the sensor device B being shared, even when, in a plurality of sensor devices B, the moving range of the detection target and the measuring object 4 of the sensor 1 are different, that is, even when the entire length of the sensor 1 is different, the work of adjusting the detection position Q1 on the starting end side and the detection position Q2 on the terminating end side can be shared. As a result, a load on a worker performing the work of adjusting the detection positions Q1 and Q2 of the sensor device B can be reduced.

It is to be noted that, in the above-mentioned configuration, the first coil set C1 and the second coil set C2 have the same length dimension, but effects as the differential transformer can be obtained as long as the inductances of the two coil sets C1 and C2 are set to equal levels. That is, the length dimensions of the first coil set C1 and the second coil set C2 may be different in a range in which the effects as the differential transformer can be obtained.

Further, the length dimensions of the first coil set C1 and the second coil set C2 may be set to different lengths. In this case, the inductances can be set to equal levels by adjusting the numbers of turns of the first coil set C1 and the second coil set C2. That is, the starting end side and the terminating end side can have different detection ranges, and hence it is possible to flexibly adapt to mechanical requirements.

It is to be noted that description has been given above of a case in which the coil-to-coil gap length Y is longer than the coil set length W of each of the coil sets C1 and C2 and the length dimension W of the measuring object 4, but the coil-to-coil gap length Y may be shorter than the coil set length W of each of the coil sets C1 and C2 and the length dimension W of the measuring object 4. It is to be noted that the case of the coil-to-coil gap length Y=0 corresponds to the general differential transformer itself, and hence this case is excluded from the scope of the invention of the subject application. That is, the coil-to-coil gap length Y is only required to be larger than at least 0.

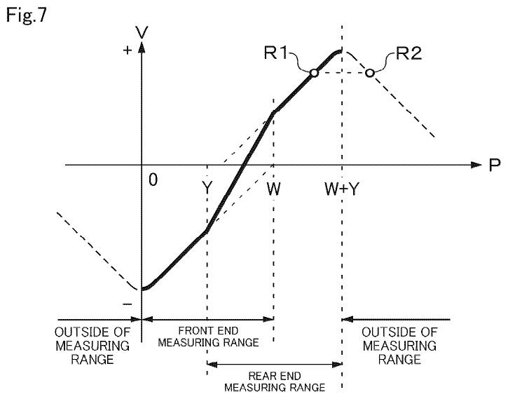

The example shown in FIG. 6 and FIG. 7 is an example of a case in which the coil-to-coil gap length Y is set to be larger than 0 and equal to or less than the coil set length W of each of the coil sets C1 and C2 and the length dimension W of the measuring object 4, that is, the coil-to-coil gap length Y is set within a range of 0<Y≤W. In this case, there is no dead zone in which the output voltage V=0 is obtained. In addition, as shown in FIG. 7, a graph having the moving amount P on the horizontal axis and the output voltage V on the vertical axis has a shape resembling an S-shaped curve.

When the moving amount P is 0≤P<Y, at least a part of the measuring object 4 overlaps the coil set C1, but the measuring object 4 does not overlap the coil set C2. In this case, as the moving amount P increases, the inductance of the coil set C1 gradually decreases when the measuring object 4 is a magnetic body, and gradually increases when the measuring object 4 is a non-magnetic body having conductivity. In contrast, the inductance of the coil set C2 does not change.

Further, when the moving amount P is Y≤P≤W, the measuring object 4 overlaps both of the coil sets C1 and C2. In this case, as the moving amount P increases, the inductance of the coil set C1 gradually decreases when the measuring object 4 is a magnetic body, and gradually increases when the measuring object 4 is a non-magnetic body having conductivity. Meanwhile, as the moving amount P increases, the inductance of the coil set C2 gradually increases when the measuring object 4 is a magnetic body, and gradually decreases when the measuring object 4 is a non-magnetic body having conductivity. Accordingly, the change amount of the inductance of the coil unit 20 is increased, and, as shown in FIG. 7, the slope of the graph of the moving amount P and the output voltage V is twice as large as that in the case of 0≤P<Y.

In addition, when the moving amount P is W<P≤W+Y, at least a part of the measuring object 4 overlaps the coil set C2, but the measuring object 4 does not overlap the coil set C1. In this case, as the moving amount P increases, the inductance of the coil set C2 gradually increases when the measuring object 4 is a magnetic body, and gradually decreases when the measuring object 4 is a non-magnetic body having conductivity. In contrast, the inductance of the coil set C1 does not change. To summarize the above, in the example of FIG. 6 and FIG. 7, the range of 0≤P<W is a front end measuring range in which the position of the measuring object 4 can be measured on the front end side, and the range of Y<P≤W+Y is a rear end measuring range in which the position of the measuring object 4 can be measured on the rear end side. In addition, the front end measuring range and the rear end measuring range overlap in a range of Y≤P<W.

Next, temperature correction of the sensor 1 is described. Copper is mainly used for the winding wire used in the primary coils 11 and 12 and the secondary coils 21 and 22. It is known that the resistance value of a conductor such as copper changes depending on the temperature of the conductor. A relationship between “resistance value of conductor” and “temperature” is expressed by the following expression.

RT=Rt{1+αt(T−t)}[Ω] (1)
RT: Resistance value [2] of conductor when temperature changes to T [°C]
Rt: Resistance value [Ω] at t [°C]
αt: Resistance temperature coefficient [ppm/°C] at t [°C]

The resistance temperature coefficient at in the expression (1) described above is a coefficient that indicates a rate of change in resistance value per 1 °C, and is 0.00393 in the case of general copper. Further, the resistance value of each of the coil units 10 and 20 is determined by the resistivity specific to the winding wire used in each of the coil units 10 and 20 and the length of the winding wire, and is a specific value depending on specifications of each of the coil units 10 and 20. Accordingly, the current temperature of the coil units 10 and 20, that is, the temperature T of the sensor 1 can be measured based on the initial resistance value Rt of the coil units 10 and 20, the temperature t at the time of that resistance value Rt, and the current resistance value RT. In addition, the above-mentioned function makes it possible to measure the temperature inside of the sensor 1, thereby making it easier to perform temperature correction with higher accuracy.

Specifically, for example, the internal temperature of the sensor 1 can be measured as follows. First, a DC current is caused to flow through both ends of any one of the primary coil unit 10 and the secondary coil unit 20. Next, the DC voltage across both ends of the coil unit 10 or 20 through which the DC current is caused to flow is measured, and the current resistance value RT is measured based on this DC voltage. Then, the temperature T of the sensor 1 is calculated from the expression (1) described above based on the resistance value Rt set in advance and the temperature t.

In the above-mentioned sensor devices A and B, for example, when the internal temperature of the sensor 1 is measured by the primary coil unit 10, a DC current superimposed on an AC signal supplied from the signal source 2 is supplied to the primary coil unit 10. Then, the voltage across both ends of the primary coil unit 10, in this case, a voltage converted to DC by filtering is measured, and the supplied DC current and the measured DC voltage are measured. Thus, the resistance value of the primary coil unit 10 can be calculated. In this case, in order to accurately measure the DC resistance of the primary coil unit 10, a circuit that measures the resistance value may be configured by using, for example, a four-wire wiring method.

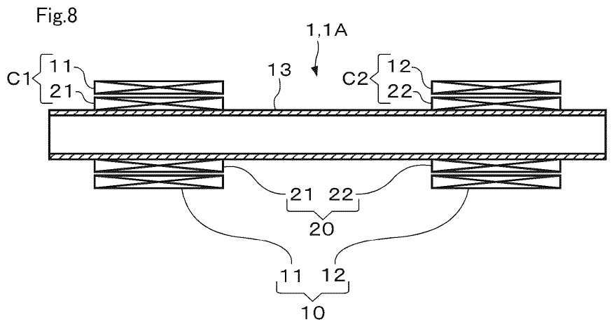

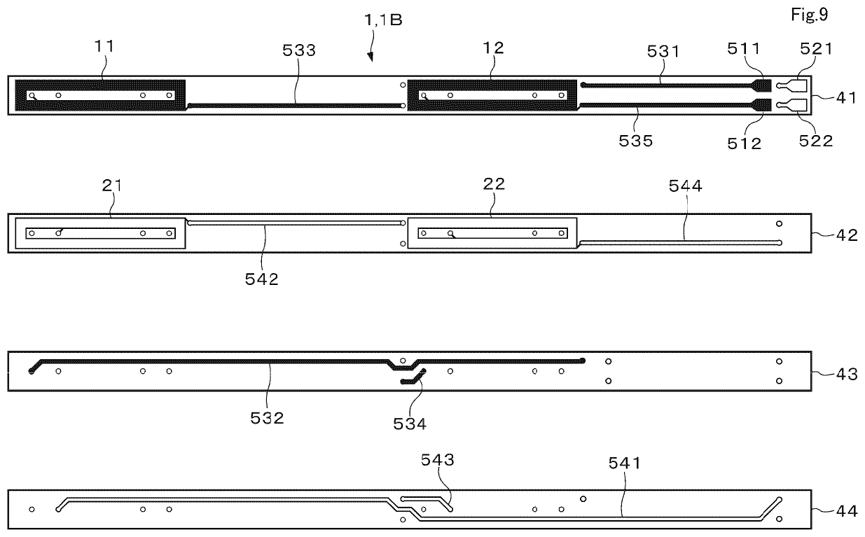

Next, with reference to FIG. 8 and FIG. 9, a configuration example of each of the coils 11, 12, 21, and 22 is described. It is to be noted that the sensor 1 illustrated in FIG. 8 is referred to as a sensor 1A, and the sensor 1 illustrated in FIG. 9 is referred to as a sensor 1B for discrimination. The sensor 1A illustrated in FIG. 8 is an example in which each of the coils 11, 12, 21, and 22 is configured of a winding wire such as a copper wire. The sensor 1A of FIG. 8 includes a coil holder 13. The coil holder 13 is configured in, for example, a cylindrical or rectangular tube shape. Each of the coils 11, 12, 21, and 22 is configured of a winding wire such as a copper wire, and is wound around the outer circumference of the coil holder 13.

The coil holder 13 has a function of maintaining the self-shape of each of the coils 11, 12, 21, and 22, and a function of fixing relative positions. The coil holder 13 may be configured of metal having conductivity. However, when the coil holder 13 is configured of a conductor, the coil holder 13 may act as a short-circuit coil to lower the inductance of each of the coils 11, 12, 21, and 22. Thus, when a conductor is used for the coil holder 13, as a material, it is preferable to use a member with high electrical resistance, that is, stainless steel or nickel alloy which allows a small current to flow as a short-circuit coil. Further, the thickness of the coil holder 13 is also preferably thinner. It is to be noted that the coil holder 13 may be configured of an insulator such as resin.

Further, the coil holder 13 may use a magnetic material. With the use of a magnetic material for the coil holder 13, the inductance of each of the coils 11, 12, 21, and 22 can be increased, and thus the sensitivity can be increased, that is, the signal change can be increased. It is to be noted that, when a magnetic material is used for the coil holder 13, attention is required to be paid to temperature characteristics or the like. Further, in a case of a configuration in which the measuring object 4 passes the inner peripheral side of the coil holder 13, a non-magnetic material or an insulator is selected for the coil holder 13 in order to obtain a signal change.

Further, an insulator may also be provided between the coil holder 13 and each of the coils 11, 12, 21, and 22. The winding wire, that is, the magnet wire configuring each of the coils 11, 12, 21, and 22 is insulated by an insulating coating or the like, and thus it is not always required to provide an insulator between the coil holder 13 and each of the coils 11, 12, 21, and 22. However, with an insulator being provided between the coil holder 13 and each of the coils 11, 12, 21, and 22, a dielectric withstand voltage between the coil holder 13 and each of the coils 11, 12, 21, and 22 can be improved.

The sensor 1B illustrated in FIG. 9 is an example in which each of the coils 11, 12, 21, and 22 is configured of a coil pattern provided on a printed circuit board. In the example of FIG. 9, the primary coil unit 10 and the secondary coil unit 20 of the sensor 1B are configured of coil patterns provided in a spiral shape on printed circuit boards 41 and 42, respectively. In the example of FIG. 9, for the sake of convenience of description, a pattern related to the primary coil unit 10 is shown in black, and a pattern related to the secondary coil unit 20 is shown in white. The sensor 1B is configured by stacking a first layer board 41, a second layer board 42, a third layer board 43, and a fourth layer board 44. The patterns provided on the respective boards 41, 42, 43, and 44 are connected via through holes as required. Land patterns 511, 512, 521, and 522 connected to the respective coils 11, 12, 21, and 22 are provided on the first layer board 41.

The coil patterns of the primary coils 11 and 12 are provided on the first layer board 41 that is the outermost layer of the sensor 1B. The land pattern 511 is connected to the primary coil 11 that is farther from the land pattern 511 out of the two primary coils 11 and 12, via a connection pattern 531 provided on the first layer board 41 and a connection pattern 532 provided on the third layer board 43. Further, the two primary coils 11 and 12 are cumulatively connected to each other via a connection pattern 533 provided on the first layer board 41 and a connection pattern 534 provided on the third layer board 43. In addition, the primary coil 12 that is closer to the land pattern 512 out of the two primary coils 11 and 12 is connected to the land pattern 512 via a connection pattern 535 provided on the first layer board 41.

The coil patterns of the secondary coils 21 and 22 are provided on the second layer board 42. The land pattern 521 is connected to the secondary coil 21 that is farther from the land pattern 521 out of the two secondary coils 21 and 22, via a connection pattern 541 provided on the fourth layer board 44. Further, the two secondary coils 21 and 22 are differentially connected to each other via a connection pattern 542 provided on the second layer board 42 and a connection pattern 543 provided on the fourth layer board 44. In addition, the secondary coil 22 that is closer to the land pattern 522 out of the two secondary coils 21 and 22 is connected to the land pattern 522 via a connection pattern 544 provided on the second layer board 42.

As described above, with each of the coils 11, 12, 21, and 22 being formed as a coil pattern on the printed circuit board 41 or 42, highly-accurate manufacturing techniques for the printed circuit board can be used. This makes it possible to inexpensively manufacture the coil patterns having the same dimension, that is, the sensor 1B having the same characteristic and few fluctuations. Moreover, at the time of mounting the sensor 1B, wiring can be simply performed by, for example, soldering signal lines to the land patterns 511, 512, 521, and 522, and hence the workability is good. Further, at the time of changing the coil length W of each of the coils 11, 12, 21, and 22, the coil-to-coil gap length Y, and the like at the time of the design of the sensor 1B, it is only required to change the layout data in CAD or the like, and hence the design changes can be easily and accurately performed.

It is to be noted that, in the example of FIG. 9, the sensor 1B is configured by stacking four layers of printed circuit boards 41 to 44, but the inductances of the coil units 10 and 20 can be easily increased by increasing the number of printed circuit boards on which the coil patterns of the coils 11, 12, 21, and 22 are provided. In this case, no electronic components such as ICs or transistors are provided on each of the printed circuit boards 41 to 44. Accordingly, each of printed circuit boards 41 to 44 can be configured thin, with the result that, even when the number of stacked printed circuit boards is increased, the thickness does not excessively increase, and a thin and compact configuration can be achieved.

Further, when the printed circuit boards 41 to 44 are made of epoxy resin containing glass, the sensor 1B can be made lightweight and highly rigid. This eliminates the need to use a reinforcing member different from the printed circuit boards 41 to 44, which makes it possible to provide a configuration being less liable to break and having high reliability. Further, the printed circuit board is generally easy to process and can be relatively easily shaped to have a free outer shape. Accordingly, the outer shape of the sensor 1B can be a shape providing good workability at the time of assembly. For example, protrusions, recesses, and even spring structures for fitting the sensor 1B to an attachment target when attaching the sensor 1B can be easily provided on the printed circuit boards 41 to 44.

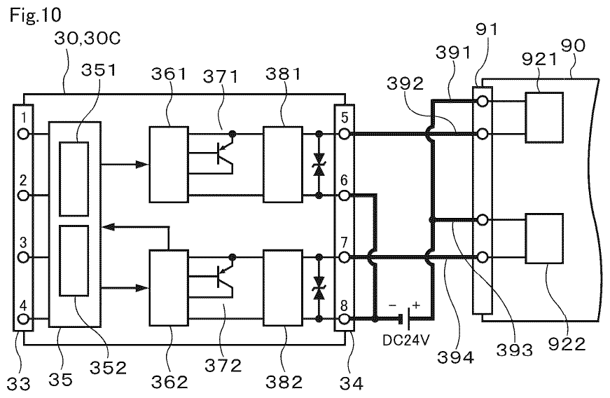

Further, in the sensor device B of FIG. 4, the converter 30B can be replaced with a converter 30C of FIG. 10. The converter 30C of FIG. 10 is an example of a two-wire configuration that does not use the signal source 2 for driving the sensor. That is, a signal line that connects the converter 30C and the higher-level device 90 is configured to have a two-wire system. In this case, the converter 30C also functions as a signal source that supplies electric power to excite the primary coil unit 10.

The converter 30C in the example of FIG. 10 includes, for example, an input terminal block 33, an output terminal block 34, a sensor internal circuit 35, a starting end output circuit 361, a terminating end output circuit 362, transistors 371 and 372, and non-polarized circuits 381 and 382. The primary coil unit 10 and the secondary coil unit 20 are connected to four terminals of the input terminal block 33.

Detection units 921 and 922 of the higher-level device 90 are connected to respective terminals of the output terminal block 34 via a terminal block 91 included in the higher-level device 90, such as a PLC or the like. The detection units 921 and 922 are configured of, for example, photocouplers or the like, and detect ON/OFF signals respectively output from the output circuits 361 and 362. In this case, the detection units 921 and 922 each have a two-wire configuration in which two signal lines 391 and 392 or two signal lines 393 and 394 are connected. Accordingly, a conventional two-wire reed switch can be easily replaced with the sensor device B of this configuration.

The sensor internal circuit 35 includes a drive circuit 351 that drives the sensor 1, and a comparison circuit 352. The comparison circuit 352 has a function of detecting the sensor signal, comparing the sensor signal with each of the reference voltages Vref1 and Vref2, and transmitting an ON/OFF command of contact output to the starting end output circuit 361 and the terminating end output circuit 362. Here, in order to achieve two-wire drive, it is required to reduce current consumption of the sensor internal circuit 35. Specifically, it is required to reduce the current consumption of the sensor internal circuit 35 to 1 mA or less. This current consumption is a current input from the signal line 392 or 394, and is a current flowing through the detection unit 921 or 922 of the higher-level device 90. When the current flowing through the detection units 921 and 922 is sufficiently small, the higher-level device 90 determines that the input is OFF. Even when this input is OFF, that is, the current is sufficiently small, the sensor device B of this embodiment, that is, the sensor 1 and the converter 30C are configured to operate. The current value at which the input is determined as OFF in the higher-level device 90 varies depending on the specifications of the higher-level device 90, but is often 1 mA or less.

The starting end output circuit 361 and the terminating end output circuit 362 are circuits that turn ON/OFF the contact output with respect to the higher-level device 90 based on the ON/OFF command transmitted from the sensor internal circuit 35. In this case, the starting end output circuit 361 performs the contact output on the starting end side, and the terminating end output circuit 362 performs the contact output on the terminating end side. Further, in the example of FIG. 10, the electric power for driving the sensor internal circuit 35 is supplied from the terminating end output circuit 362.

The non-polarized circuits 381 and 382 are provided to allow the polarity of the current of the contact output to adapt to any one of a sink that is a system that draws a current from the higher-level device 90 to the converter 30C, and a source that is a system that discharges a current from the converter 30C to the higher-level device 90, and are configured of, for example, bridge circuits using diodes. It is to be noted that the non-polarized circuits 381 and 382 can also be configured using FETs instead of diodes. When the FETs are used, the circuits become more complex, but the ON resistance can be reduced.

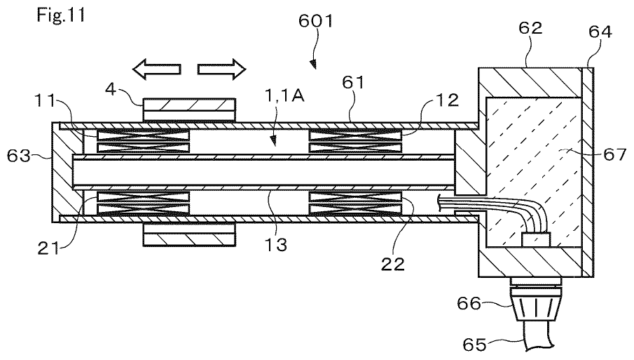

Next, with reference to FIG. 11 to FIG. 13, a sensor unit using the sensor 1 is described. The example illustrated in FIG. 11 uses the sensor 1A illustrated in FIG. 8, and is an example in which the measuring object 4 is disposed on the outer peripheral side of the sensor 1A. A sensor unit 601 illustrated in FIG. 11 includes the sensor 1A, the measuring object 4, a sleeve 61, a case 62, a front end cover 63, a rear end cover 64, and a lead-out cable 65. The coil holder 13 and the coil units 10 and 20 are disposed inside the sleeve 61. Further, the measuring object 4 is disposed to be movable outside of the sleeve 61, that is, outside of the coil units 10 and 20.

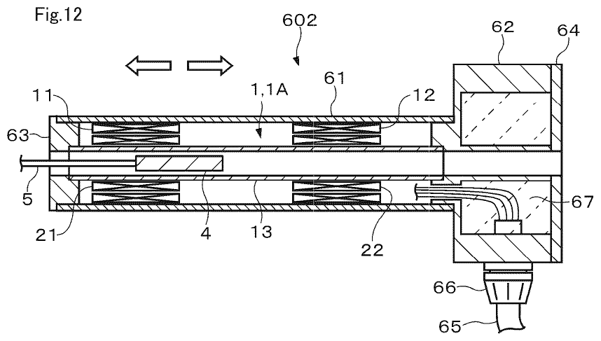

The example illustrated in FIG. 12 uses the sensor 1A illustrated in FIG. 8, and is an example in which the measuring object 4 is disposed inside of the sensor 1A. A sensor unit 602 illustrated in FIG. 12 includes the sensor 1A, the measuring object 4, the sleeve 61, the case 62, the front end cover 63, the rear end cover 64, and the lead-out cable 65. The coil holder 13 and the coil units 10 and 20 are disposed inside the sleeve 61. Furter, the measuring object 4 is also disposed to be movable inside of the sleeve 61, that is, inside of the coil units 10 and 20. In this case, the measuring object 4 is supported by a support 5.

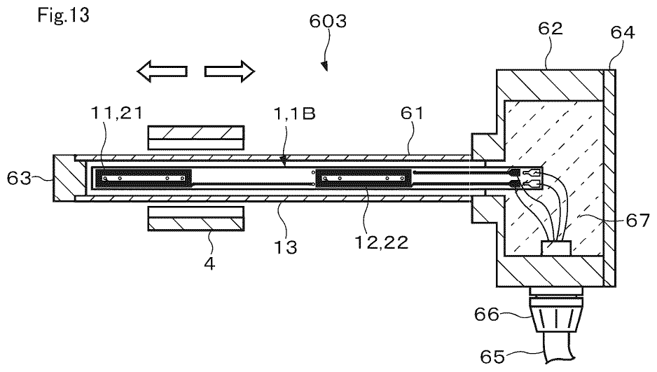

The example illustrated in FIG. 13 uses the sensor 1B illustrated in FIG. 9, and is an example in which the measuring object 4 is disposed outside of the sensor 1B. A sensor unit 603 illustrated in FIG. 13 includes the sensor 1B, the measuring object 4, the sleeve 61, the case 62, the front end cover 63, the rear end cover 64, and the lead-out cable 65. The sensor 1B is disposed inside the sleeve 61. The measuring object 4 is disposed to be movable outside of the sleeve 61, that is, outside of the coil units 10 and 20.

In the configurations of FIG. 11 to FIG. 13, the sleeve 61 is a configuration for sealing the sensor 1A or 1B to achieve mechanical protection. In a configuration in which the measuring object 4 is disposed outside of the coil units 10 and 20 as in the sensor unit 601 of FIG. 11 and the sensor unit 603 of FIG. 13, the sleeve 61 is configured of a non-magnetic material. In this case, even though the sleeve 61 is made of a non-magnetic material, when a material having high conductivity is used, the sleeve 61 itself acts as a short-circuit coil. This reduces the inductances of the coil units 10 and 20, with the result that the change in inductance is reduced, that is, the change in signal is reduced. Accordingly, in the examples of FIG. 11 and FIG. 13, the sleeve 61 is preferably made of a non-magnetic material with high electrical resistance, such as austenitic stainless steel or a nickel alloy.

Further, for the same reason as above, it is preferable that the thickness of the sleeve 61 be thinner. However, it is required to consider the balance with the mechanical strength. In particular, when the sensor 1A is built into a hydraulic cylinder or the like, the sleeve 61 is required to have a thickness that prevents damage. In an application in which a large pressure is not applied or an application in which waterproofing is not required, the sleeve 61 can be made of glass fiber reinforced resin or carbon fiber reinforced resin. This makes it possible to achieve lighter weight and lower cost.

The lead-out cable 65 is provided to lead out the wiring of the coil units 10 and 20 to the outside of the case 62, and is connected to the detector circuit 3 or the sensor internal circuit 35 outside the case 62. The end of the lead-out cable 65 may have, for example, a connector attached thereto. The lead-out cable 65 is fixed to the case 62 by, for example, a cable gland 66. This cable gland 66 ensures waterproofing between the case 62 and a sheath of the lead-out cable 65.

It is to be noted that a gap is present inside of the sheath of the lead-out cable 65. Accordingly, when the connector at the end of the lead-out cable 65 is not connected or the sheath of the lead-out cable 65 is damaged, liquid may enter the case 62 through the gap inside of the sheath of the lead-out cable 65. Accordingly, it is possible to prevent liquid from entering the case 62 along the lead-out cable 65 by filling the case 62 with epoxy resin 67 or the like.

As described above, the displacement detection sensor 1 is a sensor that detects two separated positions. The displacement detection sensor 1 includes the primary coil unit 10 and the secondary coil unit 20. The primary coil unit 10 is excited by receiving supply of electric power from the signal source 2 or 30C. The secondary coil unit 20 is disposed at a position to be magnetically coupled to the primary coil unit 10. The primary coil unit 10 and the secondary coil unit 20 change in inductances of the primary coil unit 10 and the secondary coil unit 20 when the measuring object 4 configured of a magnetic body or a non-magnetic body having conductivity moves relative to the primary coil unit 10 and the secondary coil unit 20. In addition, one of the primary coil unit 10 and the secondary coil unit 20 is configured to include two differentially-connected coils 21 and 22 that are disposed away from each other.

In this manner, when only predetermined ranges from both ends of the moving range of the detection target or the measuring object 4, that is, predetermined ranges from both ends of the entire length of the sensor 1 are to be detected, while an advantage of a differential transformer is obtained, the circuit configuration can be shared even when the moving range of the detection target varies.

Further, in the displacement detection sensor 1B, the primary coil unit 10 and the secondary coil unit 20 are configured of coil patterns provided on the printed circuit boards 41, 42, 43, and 44. In this manner, with the use of the technology of the printed circuit board, the primary coil unit 10 and the secondary coil unit 20 can be mass-produced with high accuracy and at low cost.

Further, the sensor device B of the embodiment also includes the converter 30C that outputs a position signal indicating the position of the measuring object 4 based on an induced electromotive force of the secondary coil unit 20, the converter 30C including signal lines configured to have a two-wire system. In this manner, a conventional two-wire reed switch can be easily replaced with the sensor device B of this configuration.

Moreover, the sensor device B includes the above-mentioned displacement detection sensor 1, 1A, or 1B and the converter 30B or 30C. The converter 30B or 30C are allowed to adjust the reference voltages Vref1 and Vref2 to adjust the detection positions Q1 and Q2 of the measuring object 4. In this manner, when adjusting the detection positions Q1 and Q2, the operator is only required to adjust the values of the reference voltages Vref1 and Vref2, and is not required to adjust the detection positions mechanically. Accordingly, according to the sensor device B of this configuration, it is easier to adjust the detection positions than, for example, a reed switch that has only binary values of contact ON and OFF and requires mechanical adjustment. Further, in general, the converter 30B or 30C is installed outside a device or the like in which the displacement detection sensors 1, 1A, or 1B is incorporated. Accordingly, even when it is difficult to secure a working space around the displacement detection sensor 1, 1A, or 1B, the detection positions Q1 and Q2 can be adjusted at a location away from the displacement detection sensor 1, 1A, or 1B. As a result, this configuration further improves the workability regarding adjustment of the detection positions Q1 and Q2.

The embodiments described above are presented as examples and are not intended to limit the scope of the invention. Those novel embodiments can be implemented in various other forms, and various omissions, substitutions, and modifications can be made without departing from the gist of the invention. The embodiments and modifications thereof are within the scope and gist of the invention, and are included in the scope of the invention and its equivalents as set forth in the claims.

1. A displacement detection sensor that is a sensor that detects two separated positions, the displacement detection sensor comprising:
a primary coil unit to be excited by receiving supply of electric power from a signal source; and
a secondary coil unit disposed at a position to be magnetically coupled to the primary coil unit,
wherein the primary coil unit and the secondary coil unit change in inductances of the primary coil unit and the secondary coil unit when a measuring object configured of a magnetic body or a non-magnetic body having conductivity moves relative to the primary coil unit and the secondary coil unit, and
wherein one of the primary coil unit and the secondary coil unit is configured to include two differentially-connected coils that are disposed away from each other.

2. The displacement detection sensor according to claim 1, wherein the primary coil unit and the secondary coil unit are configured of coil patterns provided on printed circuit boards.

3. A sensor device comprising:
the displacement detection sensor according to claim 1; and
a converter that outputs a position signal indicating a position of the measuring object based on an induced electromotive force of the secondary coil unit, the converter including signal lines configured to have a two-wire system.

4. A sensor device comprising:
the displacement detection sensor according to claim 1; and
a converter that allows reference voltages to be adjusted to adjust detection positions of the measuring object.
